(19) United States
(12) Patent Application Publication
(10) Pub. No.: US 2003/0198927 A1
(43) Pub. Date: Oct. 23, 2003

(54) Interactive computer system with doll character

(76) Inventor: Karen E. Campbell, Rotherham (GB)

Correspondence Address: HARSHAW RESEARCH INCORPORATED, P O BOX 418, OTTAWA, KS, 66067, US

(21) Appl. No.: 10/125,137

(22) Filed: Apr. 18, 2002

(51) Int. Cl. G09B 5/00

(52) U.S. Cl. 434/307 R

(57) ABSTRACT

A computer system includes a computer having a CPU with a memory for storing program instructions executable by the CPU. The system includes a database having predetermined operating system operations and program operation conditions and corresponding output signals. The CPU compares encountered operating system operations and program operation conditions with the predetermined data and energizes a speaker with respective output signals to emit respective sounds. A doll character separate from the PC includes a microphone for receiving speaker-emitted sounds and a control unit having a memory for storing predetermined sounds and corresponding action signals. Upon recognizing a received sound as matching a predetermined sound, the control unit energizes connected output devices with respective action signals. The output devices include servo-motors for manipulating portions of the doll character, light sources, and a sound generator. Therefore, the doll character is controlled by computer-generated sounds resulting from use of the computer.

### BACKGROUND OF THE INVENTION

This invention relates generally to a doll character separate from a computer that operates audibly and visually according to sounds emitted by the computer that are indicative of operating system operations or program operating conditions caused by the computer user.

Stuffed animals and dolls used by children as sources of entertainment and security are well-known. Further, the use of computers as a means of education and entertainment has also gained wide-spread popularity. However, the use of a computer by a child is frequently an intimidating or even lonely pursuit.

A physical character that interacts according to what is displayed on a computer display is disclosed in U.S. Pat. No. 5,977,951 while a user's manipulation of a personalized entity is transmitted to a computer which then returns data to the personalized entity to prompt an action in U.S. Pat. No. 6,319,010. Although assumably effective for their intended purposes, the existing devices and systems do not provide a pet-like doll character that provides security and companionship to a child computer user in response to sounds generated by the computer associated with computer operating system operations or software program operating conditions.

Therefore, it is desirable to have an interactive computer system having a pet-like doll character that provides companionship to a child while operating a computer. Further, it is desirable to have a system having a doll-like character that moves, speaks, and is lighted according to computer operating system operations and program operating conditions. It is also desirable to have a system in which a doll character is operable as a result of sounds emitted from a computer in response to predetermined computer operations or conditions.

### SUMMARY OF THE INVENTION

Accordingly, an interactive computer system includes a computer having a central processing unit (“CPU”) and a memory in which program instructions executable by the CPU may be stored. The system includes a database having a plurality of predetermined operating system operations and predetermined program operation conditions along with a plurality of output signals associated with respective operating system operations and program operation conditions. The CPU is capable of comparing encountered operating system operations and program operation conditions with the predetermined operations and conditions stored in the database and delivering respective output signals to the computer's speaker. Therefore, a sound associated with an encountered operating system operation or program operation condition is emitted.

The computer system according to this invention further includes a pet-like doll character separate from the computer. The doll character includes a control unit and a microphone connected thereto that is capable of receiving a sound emitted by a computer, the received sound being communicated to the control unit. A memory connected to the control unit includes predetermined sound data and associated action signals. Upon recognizing a received sound as matching a respective predetermined sound, the control unit sends appropriate action signals to output devices connected thereto within the doll character so as to manipulate the doll character, energize lights, or actuate sound circuitry. Therefore, sounds emitted from a computer associated with encountered operating system operations or computer software program conditions cause operation of a physical pet-like character separate from the computer.

Therefore, a general object of this invention is to provide an interactive computer system having a pet-like doll character that is operable according to sounds generated by a computer in response to encountering particular predetermined operating system operations or software operation conditions.

Another object of this invention is to provide an interactive computer system, as aforesaid, having a doll character that includes a framework covered by a soft outer fabric that presents a friendly companion to a child computer user.

Still another object of this invention is to provide an interactive computer system, as aforesaid, in which the doll character responds to user manipulation.

Yet another object of this invention is to provide an interactive computer system, as aforesaid, in which the doll character responds to predetermined computer-generated sounds with motion, lights, and sound.

Other objects and advantages of this invention will become apparent from the following description taken in connection with the accompanying drawings, wherein is set forth by way of illustration and example, an embodiment of this invention.

### BRIEF DESCRIPTION OF THE DRAWINGS

FIG. 1 is a perspective view of a doll character of the interactive computer system according to a preferred embodiment of the present invention;

FIG. 2 is a side view of the internal framework of the doll character as in FIG. 1 with the outer fabric removed;

FIG. 3 is a block diagram of the internal components of the doll character superimposed on a perspective view of the doll character as in FIG. 1 so as to show their relative position therein;

FIG. 4a is a block diagram illustrating the functionality of a personal computer of an interactive computer system according to a preferred embodiment of the present invention;

FIG. 4b is a block diagram illustrating the generic functionality of the doll character of the interactive computer system;

FIG. 5 is a flow chart illustrating input and output responses of the doll character of the interactive computer system; and

FIG. 6 is a block diagram of the computer of the interactive computer system.

### DESCRIPTION OF THE PREFERRED EMBODIMENT

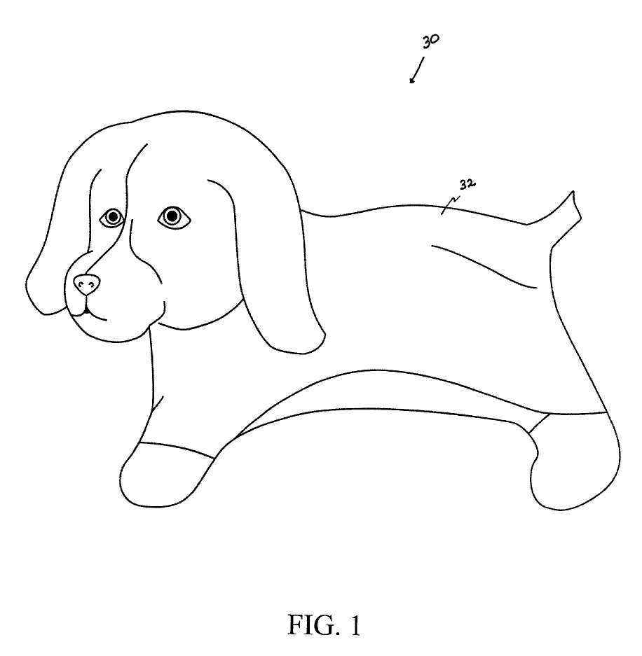

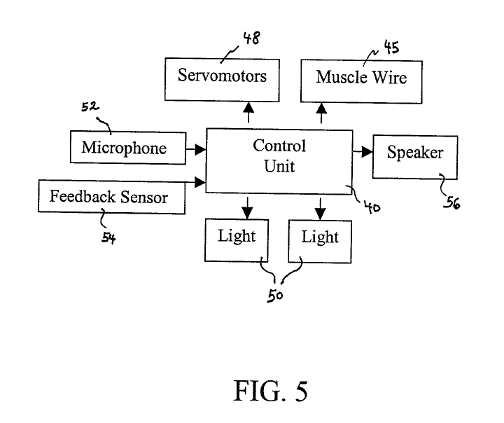

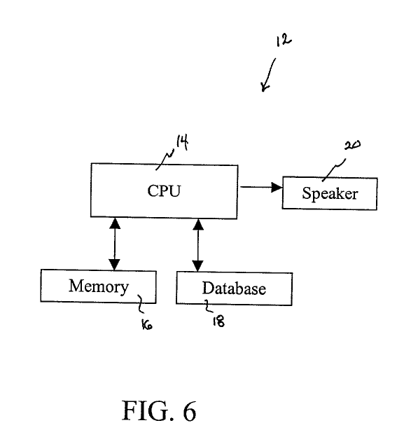

An interactive computer system according to a preferred embodiment of the present invention will now be described in detail with reference to FIGS. 1 through 5 of the accompanying drawings. An interactive computer system includes a personal computer (“PC”) 12 having a central processing unit (“CPU”) 14 electrically connected to a memory 16 and a database 18 (FIG. 6). Of course, the database 18 may be resident within the computer's memory 16 or in an external memory device. The PC 12 also includes a speaker 20 electrically connected to the CPU 14 which may also necessitate a conventional sound card 22. It should be appreciated that an entire personal computer need not be provided with the invention; rather, software including the appropriate program instructions installed on any appropriately configured computer system and executable by the CPU 14 would provide the functionality to be described below.

A plurality of program instructions capable of execution by the CPU 14 are stored in the memory 16 of the computer 12. As described previously, these program instructions may be included in a software program for installation and execution on any appropriately configured computer. In addition, the database 18 includes data associated with a plurality of predetermined operating system operations and data associated with a plurality of predetermined program operation conditions. The database 18 further includes a plurality of output signals corresponding to respective operating system operations and program operation conditions.

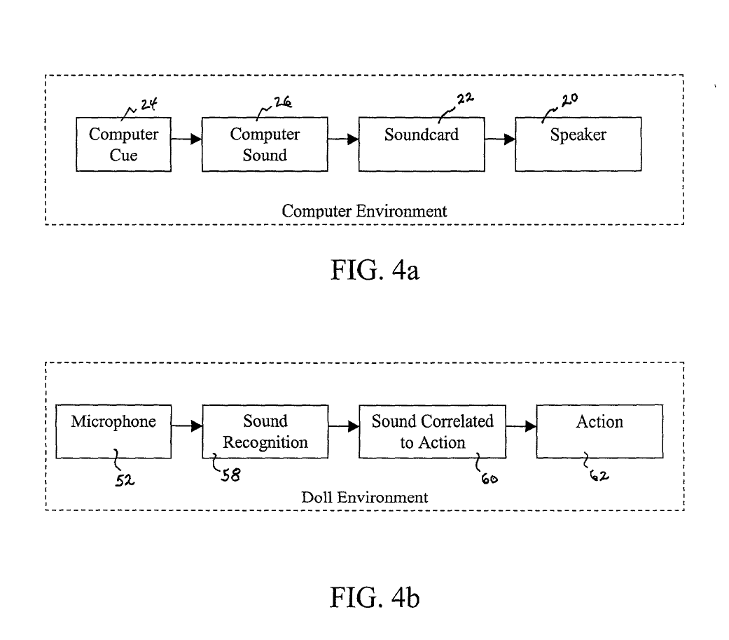

The program instructions of the present invention establish two primary modes of operation. In one mode (“operating system mode”), the CPU 14, pursuant to program instructions, detects operating system operations, such as mouse clicks, program shut-downs and launches, computer shut-downs and start-ups, saving a document, etc. In another mode (“program operation mode”), the CPU 14, pursuant to program instructions, detects program operation conditions, such as correct or incorrect responses to an educational or entertainment game module, etc. The database 18 acts as a correlation or “look-up” table in that when the CPU 14 recognizes that an encountered operating system operation or program operation condition matches a predetermined operation or condition in the database (e.g. recognizes a “computer cue” 24), the CPU 14 retrieves a respective output signal corresponding thereto and delivers it to the speaker 20 (FIG. 4a). As mentioned previously, the respective output signal may first be processed by the computer sound card 22 to provide the proper sound 26 to be emitted by the speaker 20, e.g. a bell, siren, horn, dog bark, or the like. It should be appreciated that these two modes may be executed by the CPU 14 individually or concurrently according to the program instructions and user selection.

The interactive computer system according to the present invention further includes a doll character 30 that is separate and detached from the computer 12 itself. Preferably, the doll character 30 is constructed in the form of a pet, such as a dog so that it may operate as a companion to a child while using the computer (FIG. 1). However, conventional dolls or stuffed animals would also be suitable. An exterior housing 32 (also referred to as a body housing) of the doll character 30 is preferably constructed of a soft, flexible material. Preferably, the exterior housing 32 is filled with soft pellets whereby to provide an amorphous shape and to protect delicate internal components although foam blocks, cotton balls, or the like would also provide suitable stuffing.

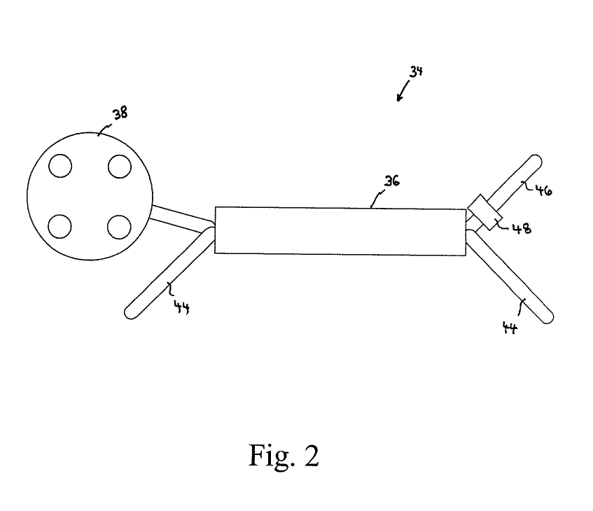

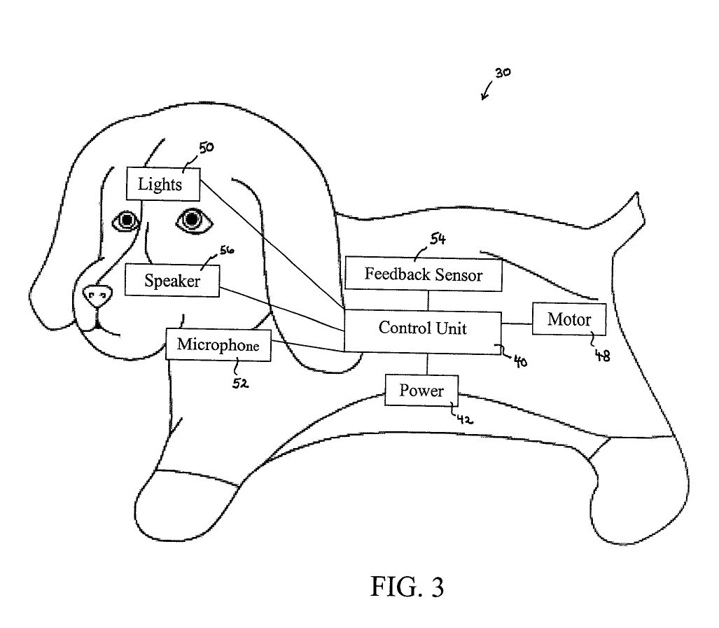

A framework 34 (FIG. 2) is also positioned within the exterior housing 32 and is constructed of a semi-flexible plastic material although a metal construction would also work. The framework 34 includes a body portion 36 and a head member 38 having a generally oval configuration extending from the body portion 36 so as to substantially hold the face of the doll character 30 in a fixed configuration. A control unit 40 is situated within the body portion 36 and is electrically connected to a battery power source 42 (FIG. 3). An on/off switch connected to the battery 42 may be positioned within an appendage of the doll character 30, e.g. a paw, although that position is not crucial. Timer circuitry for providing automatic deactivation after a period of non-use may also be connected to the battery 42 and is conventional.

The framework 34 also includes leg members 44 attached to the body portion 36 and which extend into each appendage of the doll character 30. Alternatively, the doll character 30 need not include leg members 44 and thus may provide a floppy body with less rigidity.

A generally rigid tail member 46 is pivotally coupled to the rear of the body portion 36. A servo-motor 48 is coupled to the tail member 46 and is electrically connected to the control unit 40 (FIGS. 2 and 3) for mechanically manipulating the tail member 46 when energized, as to be described more fully below. Of course, servo-motors may also be connected to the leg members 44 or even to the head member 38. Alternatively, the leg members and tail member may be in the form of a “muscle-wire” 45 constructed of a shape-memory metal alloy which contracts or expands as it is energized and de-energized. At least one light source 50 is positioned at the head member 38 of the framework 34 and electrically connected to the control unit 40 for operation as to be described below. A plurality of light sources may be included, each light source preferably being a light emitting diode (“LED”).

The doll character 30 further includes a microphone 52 positioned within the exterior housing 32, the microphone 52 being nestled within the interior pellets or coupled to the framework 34. The microphone 52 is capable of receiving a sound emitted by the computer speaker 20 and capable of delivering a respective signal to the control unit 40 to which it is electrically connected. The doll character 30 further includes a speaker 56 electrically connected to the control unit 40 and preferably mounted to the head member 38. It is understood that the speaker 56 may in fact be a sound generator, such as a speech synthesizer, or used in conjunction with a sound generator such that audible messages may be enunciated thereby. A feedback sensor 54 such as a pressure sensor is also mounted within the exterior housing 32 of the doll character 30 and is electrically connected to the control unit 40 for delivering impulses indicative of a user manipulating/petting the doll character 30 to the control unit 40. The servo-motors 48, light sources 50, speaker 56 are output devices that may be energized by the control unit 40 in response to input signals received by the control unit 40 via the feedback sensor 54 or microphone 52.

The control unit 40 includes a memory capable of storing data representing a plurality of predetermined sounds. The sound data stored in the control unit memory also includes a plurality of action signals (i.e. electric output impulses) corresponding to respective predetermined sounds. The predetermined sounds of the sound data correspond to the sounds that may be emitted by the computer speaker 20 according to respective computer database output signals. The control unit 40 is capable of comparing a sound received by the microphone 52 with the predetermined sounds of the sound data. Upon recognition of a received sound as matching a predetermined sound, the control unit 40 delivers the respective action signals to appropriate output devices (e.g. lights, speaker, servo-motors), as indicated at reference numerals 58, 60, and 62 of FIG. 4b. For example, upon recognizing a received sound as a bell, the control unit 40 may energize the appropriate servo-motor 48 to wag the tail member 46 as an indicator that a program has just been started (e.g. a corresponding operating system operation).

It is also contemplated that this invention may include an overall housing in which the doll character 30 may reside during or after use. For example, where the doll character 30 is a dog, a dog house may be included as packaging, for storage, or for active use. Doll characters having other configurations may include other housing options.

In operation, a computer software program is loaded into the memory 16 of a computer 12, the program having a plurality of instructions that are executable by the computer's CPU 14. The program may operate in operating system mode, program condition mode, or both simultaneously. In operating system mode, the CPU 14, pursuant to program instructions, is capable of comparing encountered operating system operations with a plurality of predetermined operations indicative of underlying computer events, such as computer start-up or shut-down, program closure or launch, mouse clicks, etc. Upon recognizing an encountered operation as matching a predetermined operation, the CPU 14 sends an output signal corresponding to the event to the computer's speaker 20 where an appropriate sound, e.g. a bell or siren, is emitted. The operation of the CPU 14 in program operation mode is substantially similar only predetermined program operation conditions are compared with to encountered conditions, such as responses to a video game module, educational video module, or the like. Again, respective output signals are delivered to the computer's speaker 20 upon recognition of predetermined conditions.

An emitted sound is received by the microphone 52 within the doll character 30 and communicated to the control unit 40. The control unit 40 is capable of comparing a received sound with a plurality of predetermined sounds stored in the control unit memory. Upon recognizing a received sound as matching a predetermined sound (e.g. a bell tone), the control unit 40 delivers respective action signals to output devices of the doll character 30. For example, receiving and recognizing a bell tone may result in operation of an appropriate servo-motor 48 for wagging the tail member 46 of the doll character.

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. A computer system for providing companionship to a child while using a computer, comprising:
a personal computer (PC) having a central processing unit (CPU) and a memory, said memory being adapted to store a plurality of program instructions that are executable by said CPU;
a database electrically connected to said CPU for storing data associated with a plurality of predetermined operating system operations, said operating system operation data including a plurality of output signals corresponding to said predetermined operating system operations;
a speaker electrically connected to said CPU and adapted to emit an audible sound upon receipt of a respective output signal;
a doll character separate from said PC and having a microphone for interfacing said doll character with said CPU, said microphone adapted to receive a respective audible sound emitted by said speaker;
means in said CPU for comparing an encountered operating system operation with said operating system operation data; and
wherein said CPU, responsive to said program instructions, is adapted to deliver a respective output signal corresponding to said respective operating system operation to said speaker for emission thereby upon recognition of said encountered operating system operation as matching a corresponding predetermined operating system operation.

2. The computer system as in claim 1 wherein said database is adapted to store data associated with a plurality of predetermined program operation conditions, said program operation condition data including a plurality of output signals corresponding to respective predetermined program operation conditions; said computer system further comprising:
means in said CPU for comparing an encountered program operation condition with said program operation condition data; and
wherein said CPU, responsive to said program instructions, is adapted to deliver a respective output signal corresponding to a respective predetermined program operation condition to said speaker for emission thereby upon recognition of said encountered program operation condition as matching a corresponding predetermined program operation condition.

3. The computer system as in claim 1 wherein said doll character includes:
a control unit electrically connected to said microphone and having a memory adapted to store sound data representing a plurality of predetermined sounds, said sound data including a plurality of action signals corresponding to respective predetermined sounds;
a plurality of output devices electrically connected to said control unit;
means in said control unit for comparing a received audible sound with said sound data; and
wherein said control unit is adapted to deliver respective action signals corresponding to a respective predetermined sound to said output devices upon recognition of said received sound as matching a corresponding predetermined sound, whereby to energize said output devices.

4. The computer system as in claim 3 wherein said output devices include:
a plurality of servo-motors electrically connected to said control unit and capable of manipulating portions of said doll character when said servo-motors are energized by said respective action signals; and
at least one light source electrically connected to said control unit and capable of emitting light when energized by said respective action signals.

5. The computer system as in claim 3 wherein said output devices include a sound generator electrically connected to said control unit and capable of enunciating an audible message upon receipt of and according to said respective action signals.

6. The computer system as in claim 1 wherein said audible sound is indicative of said encountered operating system operation.

7. The computer system as in claim 2 wherein said audible sound is indicative of one of said encountered program operation conditions or said encountered operating system operations.

8. The computer system as in claim 3 wherein said doll character includes a body housing, said microphone, control unit, and output devices being positioned in said body housing.

9. The computer system as in claim 8 wherein said doll character includes a pressure sensor positioned in said body housing and electrically connected to said control unit, said control unit adapted to energize respective output devices upon receiving an electric signal from said pressure sensor indicative of said doll character being manipulated by a user.

10. An interactive doll character, comprising:
a control unit having a memory adapted to store sound data representing a plurality of predetermined sounds, said sound data including a plurality of electric action signals corresponding to respective predetermined sounds;
a battery power source electrically connected to said control unit;
a microphone electrically connected to said control unit and adapted to receive an audible sound emitted by a speaker of a computer, whereby to communicate with said computer;
a plurality of output devices electrically connected to said control unit;
means in said control unit for comparing a received audible sound with said sound data; and
wherein said control unit is adapted to deliver respective action signals to said output devices upon recognition of said received sound as matching a corresponding predetermined sound of said sound data, whereby to energize said output devices.

11. The interactive doll character as in claim 10 wherein said output devices include:
at least one servo-motor electrically connected to said control unit and capable of manipulating at least one portion of said doll character when said at least one servo-motor is energized by said respective action signals; and
at least one light source electrically connected to said control unit and capable of emitting light when energized by said respective action signals.

12. The interactive doll character as in claim 11 wherein said output devices include a sound generator electrically connected to said control unit and capable of enunciating an audible message upon receipt of and according to said respective action signals.

13. The interactive doll character as in claim 10 wherein said doll character includes a body housing, said microphone, control unit, and output devices being positioned in said body housing.

14. The interactive doll character as in claim 13 further comprising a pressure sensor positioned in said body housing and electrically connected to said control unit, said control unit adapted to energize respective output devices upon receiving an electric signal from said pressure sensor indicative of said doll character being manipulated by a user.

15. An interactive computer system for providing companionship to a child when using a computer, comprising:
a personal computer (PC) having a central processing unit (CPU) and a memory, said memory being adapted to store a plurality of program instructions that are executable by said CPU;
a database electrically connected to said CPU for storing data associated with a plurality of predetermined operating system operations and data associated with a plurality of predetermined program operation conditions, said operating system operation data and said program operation condition data including a plurality of output signals corresponding to said predetermined operating system operations and said predetermined program operation conditions;
a speaker electrically connected to said CPU and adapted to emit an audible sound upon receipt of a respective output signal;
a doll character separate from said PC and having a microphone, said microphone adapted to receive a respective audible sound emitted by said speaker for interfacing said doll character with said CPU;
means in said CPU for comparing an encountered operating system operation with said operating system operation data;
wherein said CPU, responsive to said program instructions, is adapted to deliver a respective output signal corresponding to said respective operating system operation to said speaker for emission thereby upon recognition of said encountered operating system operation as matching a corresponding predetermined operating system operation;
means in said CPU for comparing an encountered program operation condition with said program operation condition data; and
wherein said CPU, responsive to said program instructions, is adapted to deliver a responsive output signal corresponding to a respective predetermined program operation condition to said speaker for emission thereby upon recognition of said encountered program operation condition as matching a corresponding predetermined program operation condition.

16. The interactive computer system as in claim 15, wherein said doll character includes:
a control unit having a memory adapted to store sound data representing a plurality of predetermined sounds, said sound data including a plurality of electric action signals corresponding to respective predetermined sounds;
a battery electrically connected to said control unit;
a plurality of output devices electrically connected to said control unit;
means in said control unit for comparing a received audible sound with said sound data; and
wherein said control unit is adapted to deliver respective action signals corresponding to a respective predetermined sound to said output devices upon recognition of said received sound as matching a corresponding predetermined sound of said sound data, whereby to energize said output devices.

17. The interactive computer system as in claim 16 wherein said output devices include:
a plurality of servo-motors electrically connected to said control unit and capable of manipulating portions of said doll character when said servo-motors are energized by said respective action signals; and
a plurality of light sources electrically connected to said control unit and capable of emitting light when energized by said respective action signals.

18. The interactive computer system as in claim 16 wherein said output devices include a sound generator electrically connected to said control unit and capable of enunciating an audible message upon receipt of and according to said respective action signals.

19. The interactive computer system as in claim 16 wherein said doll character includes a body framework, said microphone, control unit, and output devices being positioned in said body housing.

20. The interactive computer system as in claim 19 wherein said doll character includes a pressure sensor positioned in said body housing and electrically connected to said control unit, said control unit adapted to energize respective output devices upon receiving an electric signal from said pressure sensor indicative of said doll character being manipulated by a user.
